(19) United States
(12) Patent Application Publication
(10) Pub. No.: US 2006/0274279 A1
(43) Pub. Date: Dec. 7, 2006

(54) Projection display device

(75) Inventors: Shoichi Yoshii, Habikino-shi (JP); Hisashi Okada, Daito-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/446,302

(22) Filed: Jun. 5, 2006

(30) Foreign Application Priority Data
Jun. 6, 2005 (JP) 2005-165766

(51) Int. Cl. G03B 21/18

(52) U.S. Cl. 353/53

(57) ABSTRACT

The present invention has an objective to provide a projection display device of a U-shape structure with an illumination optical system folded by a mirror, which reduces heat load without using a mirror made of heat-resistant glass to fold light from a light source. A projection display device that folds light from a light source 1 composed of a lamp 1a and a parabolic metallic reflector 1b by a cold mirror 2 to be applied to light modulating elements 10B, 10G, 10R through fly-eye integrators 3, 4, thereby enlarging and projecting the light modulated by the light modulating element through a projection lens 20, wherein a cold mirror 2 is cooled by cooling air from a fan 32, ultraviolet and infrared rays transmitted through the cold mirror 2 are emitted out of a cabinet 30, so that retroreflection of ultraviolet and infrared rays to a lamp 1a is prevented.

The priority applications Number JP2005-165766 upon which this patent application is based is hereby incorporated by reference.

### BACKGROUND OF THE INVENTION

1. Field of the Invention

The present invention relates to a projection display device which displays color images.

2. Description of the Prior Art

In a projection display device which projects color images, light emitted from an illumination optical system is split into three lights with red (R), green (G) and blue (B) wavelengths respectively. The split lights of three colors are modulated respectively by liquid crystal light valves according to respective light signals. After modulated, the lights are synthesized again to form a color image which is projected from a projection lens to be projected on a screen and the like.

In the above-described projection display device, an L-shape structure in which the illumination optical system is linearly disposed, and a U-shape structure in which the illumination optical system is folded by mirrors are known. Where to absorb components of ultraviolet and infrared rays (UVIR components) except for visible light emitted from a light source as well as cooling optical components irradiated with the UVIR components are very important for the above-described projection display devices.

Conventional structure is to place a UVIR cut filter in front of the light source to remove UVIR components from the light source. However, the structure has a problem in that the temperature of a lamp burner part is induced to increase due to retroreflection of the UVIR components to the light source side, thereby shortening the life of a light source lamp.

On the other hand, a projection display device of a U-shape structure with an illumination optical system folded by mirrors is suggested in which a cold mirror is used to fold light from the light source so that visible light is reflected and UVIR components except for visible light is emitted out of the optical path. (e.g. Japanese unexamined patent publication No. 2004-129972)

Generally, a reflector made of glass is used for the light source to convert light emitted from a lamp into approximately parallel light rays. A reflector made of glass, however, will be damaged if by any chance the lamp inside explodes, which will then leave broken pieces of glass scattered inside the display device. Additionally, it takes a few minutes for the temperature of the reflector to be lowered enough to re-light the lamp burner once the lamp is extinguished, since glass does not easily cool down.

Therefore, a metallic reflector to prevent damage thereto as well as to improve its cooling characteristics is in practical use. A metallic reflector, however, reflects UVIR components and visible light frontwardly altogether, making the temperature of a cold mirror which folds light from the light source higher than when using a glass reflector, it is necessary to take care of the temperature of the cold mirror. Consequently, the cold mirror has to be made of heat-resistant glass, bringing the cost higher.

### SUMMARY OF THE INVENTION

The present invention is made in consideration of the above-described conventional problem, and has an objective to provide a projection display device of a U-shape structure with an illumination optical system folded by mirrors, which reduces heat load without using mirrors made of heat-resistant glass to fold light from the light source.

The present invention is characterized by a projection display device that folds light from a light source composed of a lamp and a parabolic reflector by a mirror to be applied to light modulating element through a fly-eye integrator, thereby enlarging and projecting light modulated by the light modulating element through a projector, wherein the reflector is composed of a metallic reflector, and a means for cooling a mirror to which light including visible light, ultraviolet and infrared rays is applied from the light source as well as a means for removing ultraviolet and infrared rays from light from the light source are provided, and the means for removing ultraviolet and infrared rays is disposed so as to prevent retroreflection of the removed ultraviolet and infrared rays to the lamp side.

And the mirror is made of a blue plate glass to be provided with an air vent to upper and lower sides of an installation surface of the mirror through which a cooling air passes along the mirror surface, thereby cooling the mirror surface.

Furthermore, a heat sink may be provided at a rear surface of the mirror to be formed in consideration of a temperature distribution of the mirror.

A cold mirror can be used for the mirror to be constructed to emit ultraviolet and infrared rays transmitted through the cold mirror out of an optical path.

Additionally, the mirror is a total reflection mirror and an ultraviolet and infrared ray cut filter may be disposed obliquely to the optical path between lenses of the fly-eye integrator, thereby constructed to emit ultraviolet and infrared rays reflected by the ultraviolet and infrared ray cut filter out of the optical path.

Also, the mirror is the total reflection mirror and a lens surface facing the mirror of the fly-eye integrator is covered with the ultraviolet and infrared ray cut filter, thereby constructed to diffuse reflected light of ultraviolet and infrared rays to a lamp side.

The present invention enables an inexpensive blue plate glass to be used for a mirror even in the case of using a metallic reflector by providing a means for cooling a mirror to which light including visible light, ultraviolet and infrared rays is applied. In addition, the present invention is constructed to prevent retroreflection of ultraviolet and infrared rays to the lamp side so that heat load to the lamp is reduced, thereby extending lamp life.

### BRIEF DESCRIPTION OF THE DRAWINGS

FIG. 1 is a schematic diagram illustrating a structure of a projection display device with an illumination optical system arranged in a U-shape according to a first embodiment of the present invention.

FIG. 2 is a schematic diagram illustrating a structure of a projection display device with an illumination optical system arranged in a U-shape according to a second embodiment of the present invention.

FIG. 3 is a schematic diagram illustrating a structure of a projection display device with an illumination optical system arranged in a U-shape according to a third embodiment of the present invention.

FIG. 4 is a schematic diagram illustrating a structure of a projection display device with an illumination optical system arranged in a U-shape according to a fourth embodiment of the present invention.

FIG. 5 is a schematic diagram illustrating a projector according to a fifth embodiment in which the present invention is used for a rear projection display device.

FIG. 6 is a schematic side view of the fifth embodiment in which the present invention is used for a rear projection display device.

FIG. 7 is a schematic front view of the fifth embodiment in which the present invention is used for a rear projection display device.

### DETAILED DESCRIPTION OF THE PREFERRED EMBODIMENTS

The present invention will be described in detail as referring to the drawings.

### The First Embodiment

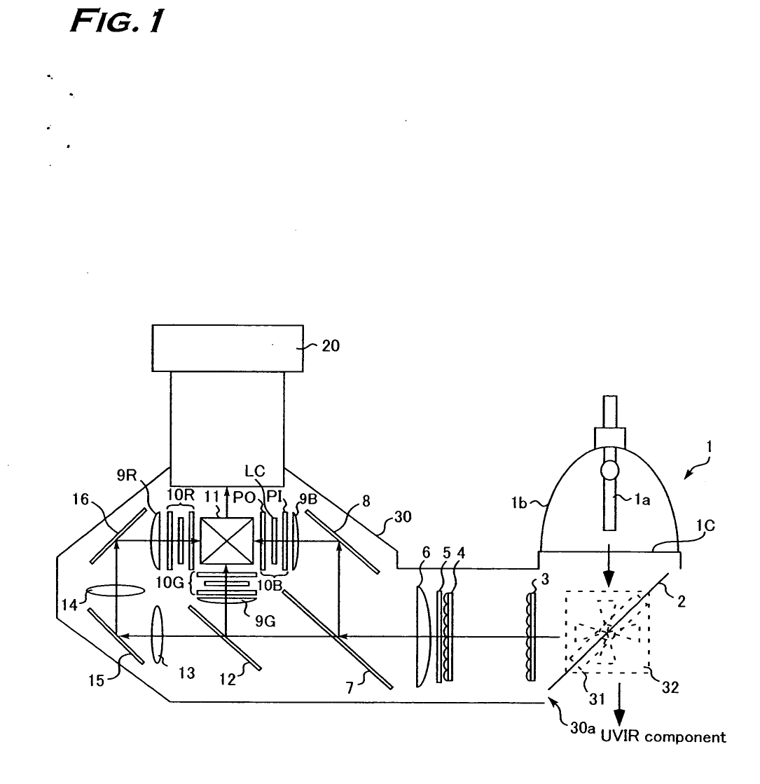

FIG. 1 is a schematic diagram illustrating a structure of a projection display device with an illumination optical system arranged in a U-shape according to a first embodiment of the present invention. Namely, the light source and the projection lens are placed respectively at each end of a U-shape arrangement. The same reference numbers are given to parts which are identical with or equivalent to each other, and their descriptions will be omitted to avoid repetition.

Referring to FIG. 1, a projection display device according to the first embodiment of the present invention includes a light source 1, fly-eye lenses 3, 4, a polarizing converter 5, a condenser lens 6, field lenses 9B, 9G, 9R, dichroic mirrors 7, 12, total reflection mirrors 8, 15, 16, liquid crystal display elements 10B, 10G, 10R, a dichroic prism 11, lenses 13, 14 and a projection lens 20.

As illustrated in FIG. 1, a light source 1 comprises a high-pressure mercury vapor lamp 1a, a parabolic metallic reflector 1b which converts white light emitted from the lamp 1a into approximately parallel light rays, and a front glass 1c. The metallic reflector 1b prevents damage thereto, improves its cooling characteristics, and shortens the period of time needed to re-light the lamp 1a. By the way, the metallic reflector 1b reflects UVIR components and visible light frontwardly altogether.

The fly-eye lenses 3, 4 are opposed to the front glass 1c of the light source 1. The polarizing converter 5 is disposed between the fly-eye lens 4 and the condenser lens 6. The condenser lens 6 is disposed between the polarizing converter 5 and the dichroic mirror 7.

The dichroic mirror 7 is disposed in the middle of the total reflection mirror 8, the dichroic mirror 12 and the condenser lens 6. The total reflection mirror 8 is disposed between the dichroic mirror 7 and the field lens 9B.

The field lens 9B is disposed between the total reflection mirror 8 and the liquid crystal display element 10B. The field lens 9G is disposed between the liquid crystal display element 10G and the dichroic mirror 12. The field lens 9R is disposed between the liquid crystal display element 10R and the total reflection mirror 16.

The liquid crystal display element 10B is disposed between the field lens 9B and the dichroic prism 11. The liquid crystal display element 10G is disposed between the field lens 9G and the dichroic prism 11. The liquid crystal display element 10R is disposed between the field lens 9R and the dichroic prism 11. Each of the liquid crystal display elements 10B, 10G, 10R includes an incident side polarizing plate PI, a liquid crystal LC and an exit side polarizing plate PO.

The dichroic prism 11 is disposed in the middle of the liquid crystal display elements 10B, 10G, 10R and the projection lens 20. The dichroic mirror 12 is disposed in the middle of the field lens 9G, the lens 13 and the dichroic mirror 7. The lens 13 is disposed between the dichroic mirror 12 and the total reflection mirror 15. The total reflection mirror 15 is disposed between the lenses 13, 14. The lens 14 is disposed between the total reflection mirrors 15, 16. The total reflection mirror 16 is disposed between the field lens 9R and the lens 14. The projection lens 20 is disposed opposing to the light-emitting surface 11A of the dichroic prism 11.

The light source 1 converts white light emitted from the lamp 1a into collimated white light and emits it from the front glass 1c to the cold mirror 2.

The optical path of the light emitted from the light source 1 is folded at a 90-degree angle by a mirror which is a cold mirror 2. The cold mirror 2 reflects visible light and transmits other light except visible light. Therefore, the UVIR components are emitted out of the optical path after transmitting the cold mirror 2. An aperture 30a is provided at a rear position of the cold mirror 2 in an engine cabinet 30 in order to emit the UVIR components emitted from the cold mirror 2 out of an engine of a projector. The cold mirror 2 transmits and emits UVIR components out of the optical path, thereby reducing heat load to the subsequent optical members. Additionally, retroreflection of the UVIR components to the light source 1 side can be prevented, so that heat load to the lamp 1a may also be reduced.

Light is emitted as parallel light from the parabolic reflector 1b. Infrared and ultraviolet components thereof transmit the cold mirror 2 while visible light is reflected, so that its optical path is folded at a 90-degree angle. Then visible light is separated into rays by a so-called fly-eye integrator consisting of a first and a second fly-eye lenses 3, 4. Each ray of the light converges and enters a polarization conversion element 5, so that the light is emitted with its polarization direction aligned.

Out of the white light from the condenser lens 6, the dichroic mirror 7 reflects blue wavelength light toward the total reflection mirror 18, while allowing light having wavelengths from red to green to pass therethrough to enter the dichroic mirror 22.

The total reflection mirror 8 bends the optical path of the blue wavelength light received from the dichroic mirror 7 at 90 degrees to direct the blue wavelength light to the field lens 9B. The field lens 9B directs the blue wavelength light from the total reflection mirror 8 to the liquid crystal display element 10B. The liquid crystal display element 10B optically modulates the blue wavelength light from the field lens 19B according to an input signal and allows the modulated blue wavelength light to enter the dichroic prism 11.

The dichroic mirror 12 reflects green wavelength light out of the light having wavelengths from red to green received from the dichroic mirror 7 to the field lens 9G, while allowing red wavelength light to pass therethrough to enter the lens 13.

The field lens 9G directs the green wavelength light received from the dichroic mirror 12 to the liquid crystal display element 10G. The liquid crystal display element 10G optically modulates the green wavelength light received from the field lens 9G according to an input signal and allows the modulated green wavelength light to enter the dichroic prism 11.

The lens 13 directs the red wavelength light from the dichroic mirror 12 to the total reflection mirror 15, which then bends the optical path of the red wavelength light at 90 degrees to direct the red wavelength light to the lens 14. The lens 14 directs the red wavelength light from the total reflection mirror 15 to the total reflection mirror 16, which then directs the red wavelength light to the field lens 9R.

The field lens 9R directs the red wavelength light from the total reflection mirror 16 to the liquid crystal display element 10R, which then optically modulates the red wavelength light from the field lens 9R according to an input signal and allows the modulated red wavelength light to enter the dichroic prism 11.

The dichroic prism 11 bends optical paths of the blue wavelength light and red wavelength light received from the liquid crystal display element 10B and 10R respectively at 90 degrees, while allowing the green wavelength light from the liquid crystal display element 10G to pass therethrough without bending its optical path in order to let the blue wavelength light, green wavelength light and red wavelength light enter the projection lens 20. The projection lens 20 enlarges and projects the blue wavelength light, green wavelength light and red wavelength light received from the dichroic prism 11 to form an image on a screen (not shown).

The metallic reflector 1b reflects UVIR components and visible light frontwardly altogether so that the cold mirror is very heated. A heat-resistant glass is generally used for the cold mirror. In this first embodiment, however, an inexpensive blue plate glass is used for the cold mirror 2. Consequently, in this embodiment, it makes possible to use the blue plate glass for the cold mirror 2 by using a means for cooling the cold mirror 2.

In the first embodiment illustrated in FIG. 1, an air vent 31 is provided at an upper and lower sides of an installation surface of the cold mirror 2 in a cabinet 30 and to blow air upwardly or downwardly from a fan 32 along the mirror surface so that the mirror surface is cooled. Consequently, cooling air is passed through from the fan 32 along the mirror surface of the cold mirror 2 which enables the prevention of rise in temperature of the cold mirror 2 and the use of the cold mirror which is made of the inexpensive blue plate glass.

### The Second Embodiment

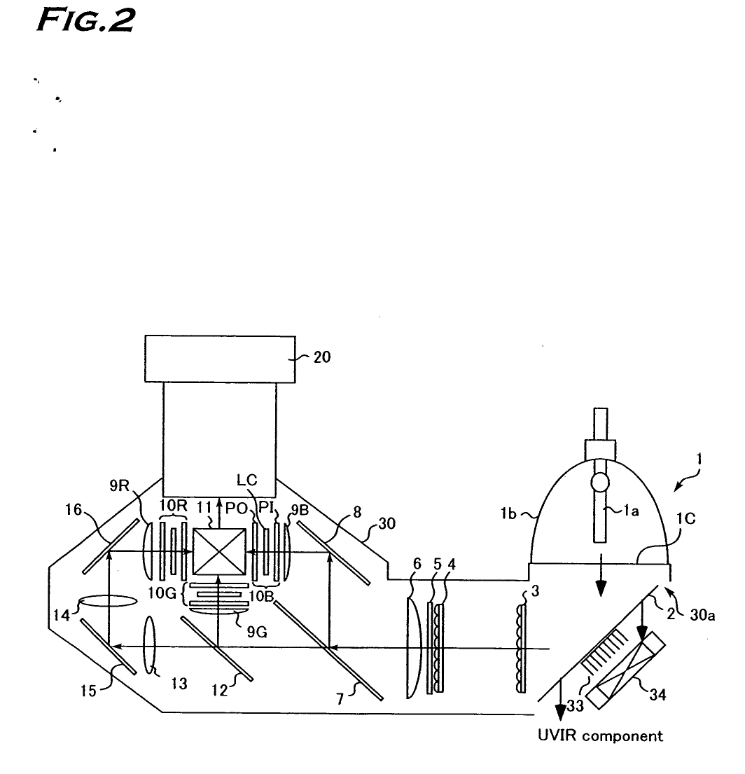

FIG. 2 is a schematic diagram illustrating the structure of the projection display device with the illumination optical system arranged in the U-shape according to the second embodiment of the present invention. In this second embodiment, a heat sink 33 is provided at a center of a rear surface of the cold mirror 2 made of the blue plate glass and to cool the heat sink 33 with cooling air from the fan 34 so that the cold mirror 2 is cooled. In this embodiment, the center part of the cold mirror 2 is most heated, and therefore a heat sink 21 is provided to improve cooling efficiency. In this embodiment, the heat sink 21 is provided at the center part. Otherwise, the shape of the heat sink 21 may be formed according to the temperature distribution of heat of the cold mirror 2. That is, it may be formed, for example, by enlarging a fin shape of the heat sink 21 or it may be increased in number so that cooling effect is enhanced where the temperature is high.

In the case when it is possible to cool the cold mirror 2 enough so as not to damage the blue plate glass by the heat sink 33 only, the fan may be unnecessary.

### The Third Embodiment

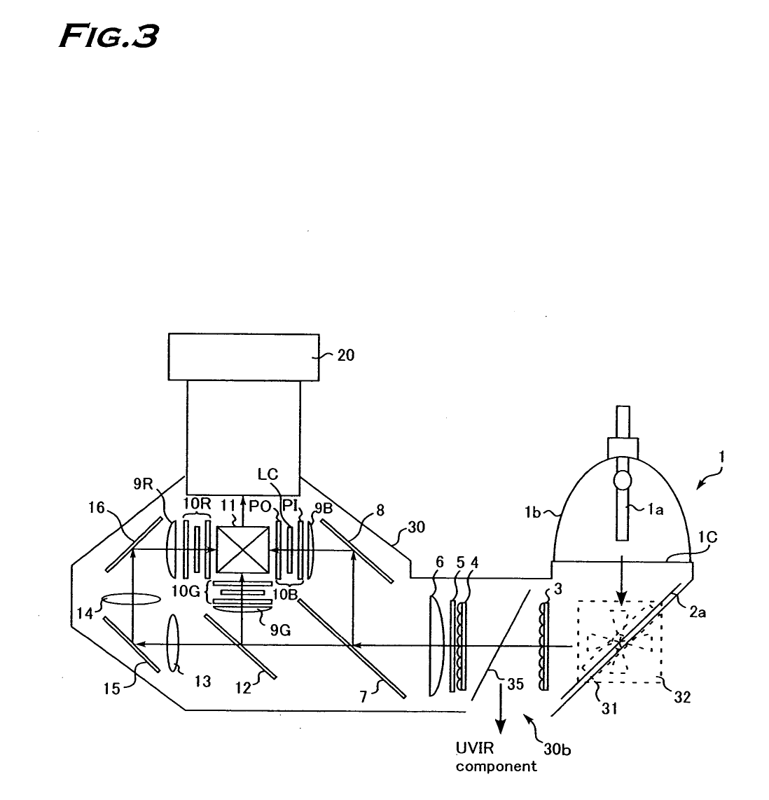

FIG. 3 is the schematic diagram illustrating the structure of the projection display device with the illumination optical system arranged in the U-shape according to the third embodiment of the present invention. In the first and the second embodiment, the light from the light source 1 is folded at a 90-degree angle by the cold mirror 2. In the third embodiment, however, the light from the light source 1 is folded by using a total reflection mirror 2a which is made of the blue plate glass. Then a UVIR cut filter 35 is obliquely placed to the optical path between a first fly-eye lens 3 and a second fly-eye lens 4. The light including the UVIR components which is directed via the total reflection mirror 2a from the light source 1 is applied to the UVIR cut filter 35 through the first fly-eye lens 3. The UVIR components are reflected by the UVIR cut filter 35 and visible light components from which the UVIR components are removed is transmitted, to be applied to the second fly-eye lens 4.

The UVIR cut filter 35 is obliquely placed to the optical path, and therefore the reflected UVIR components are reflected in the direction out of the optical path. In the embodiment, an aperture 30b is provided in the engine cabinet 3 where the light of the reflected UVIR components reaches in the engine cabinet 3. Thus, the UVIR cut filter 35 emits the UVIR components out of the cabinet 30, thereby reducing heat load-to the subsequent optical members. Additionally, retroreflection of the UVIR components to the light source 1 can be prevented, so that heat load to the lamp la may also be reduced.

As described above, the metallic reflector 1b reflects the UVIR components and visible light frontwardly altogether so that the total reflection mirror 2a is very heated. Consequently, in this embodiment, it makes possible to use the blue plate glass for the total reflection mirror 2a by using a means for cooling the total reflection mirror 2a. In the third embodiment illustrated in FIG. 3, the air vent 31 is provided at an upper and lower sides of an installation surface of the total reflection mirror 2 in the cabinet 30 and to blow air upwardly or downwardly along the mirror surface so that the mirror surface is cooled. Consequently, cooling air is passed through from the fan 32 along the mirror surface of the total reflection mirror 2a which enables the prevention of rise in temperature of the reflection mirror 2a and the use of the total reflection mirror made of an inexpensive blue plate glass. The heat sink may be provided at the rear surface of the total reflection mirror 2a like the second embodiment.

### The Fourth Embodiment

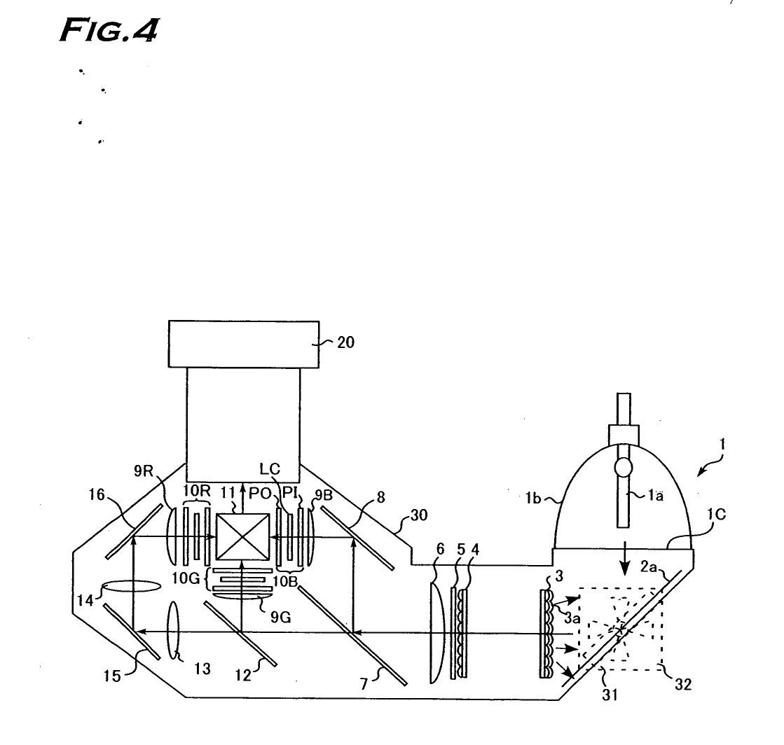

FIG. 4 is a schematic diagram illustrating a structure of a projection display device with an illumination optical system arranged in a U-shape according to a fourth embodiment of the present invention. In the fourth embodiment, UVIR cut coating 3a is applied to the lens surface at the total reflection mirror 2a side of the first fly-eye lens 3 reflected by light from the total reflection mirror 2a.

By the UVIR cut coating 3a provided on the surface of the first fly-eye lens 3, retroreflected light to the lamp side is diffused and heat load to the lamp side is reduced.

In the fourth embodiment, the air vent is provided at an upper and lower sides of the installation surface of the total reflection mirror 2 in the cabinet 30 and to blow air from upwardly or downwardly from a fan 32 along the mirror surface so that the mirror surface is cooled. Consequently, cooling air is passed through from the fan 32 along the mirror surface of the total reflection mirror 2a which enables the prevention of rise in temperature of the reflection mirror 2a and the use of the total reflection mirror which is made of an inexpensive blue plate glass. As the second embodiment, the heat sink may be provided at the rear of the total reflection mirror 2a. The heat sink may be provided at the rear surface of the total reflection mirror 2a like the second embodiment.

### The Fifth Embodiment

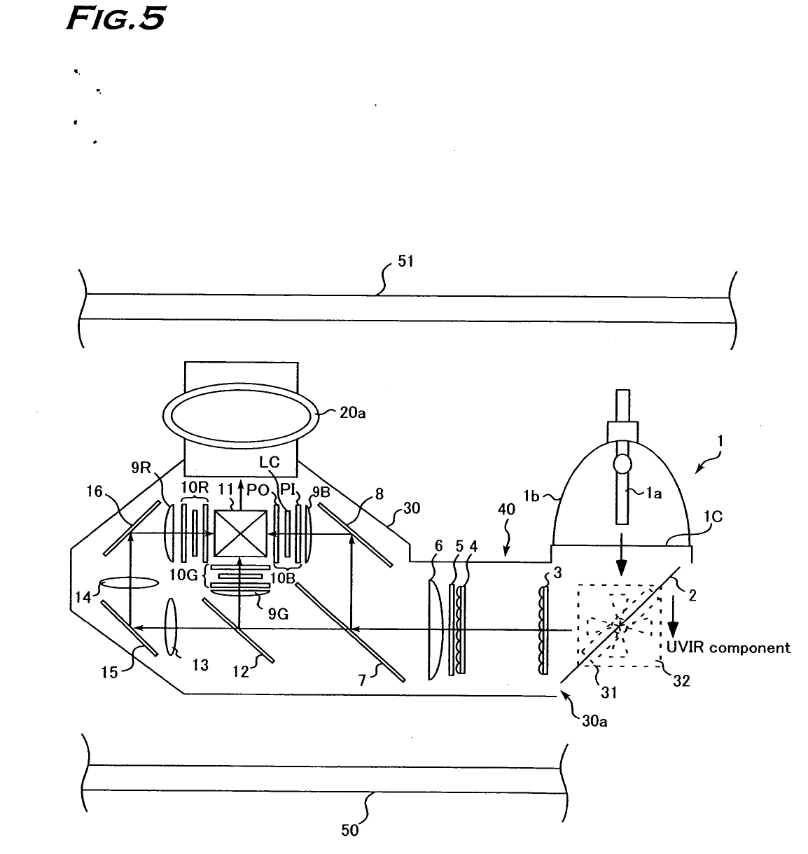

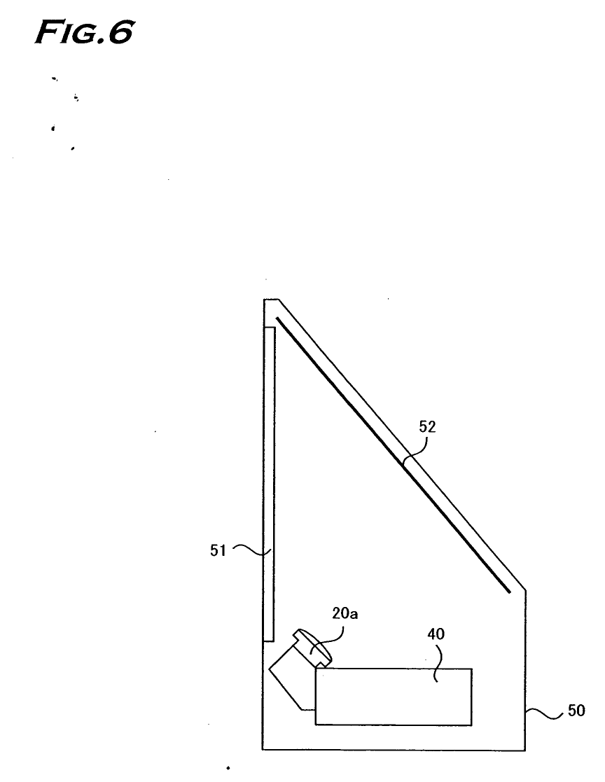

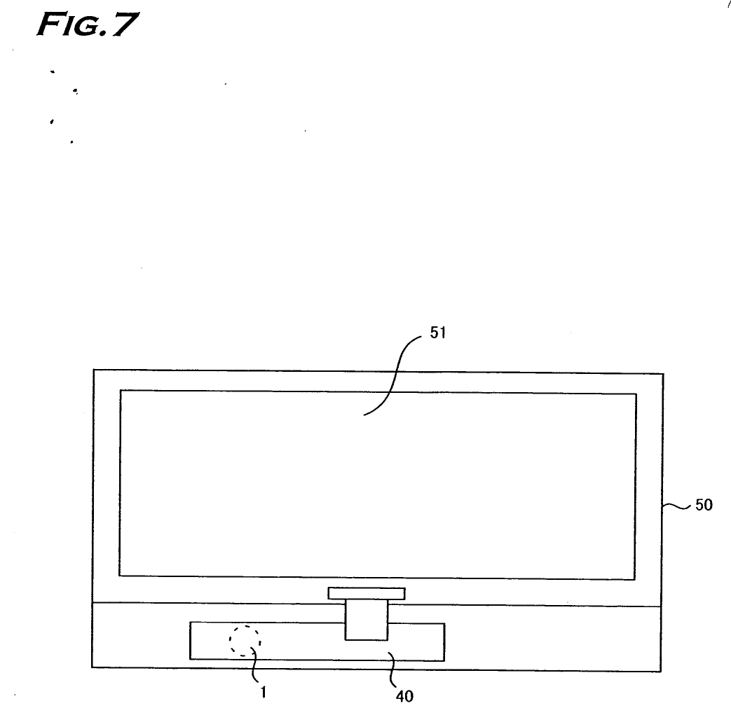

FIG. 5 to FIG. 7 illustrates the fifth embodiment in which the present invention is used for a rear projection display device. FIG. 5 is a schematic diagram illustrating the structure of the projector, FIG. 6 is a schematic side view, and FIG. 7 is a schematic front view.

A projector engine 40 in the rear projection display device according to this embodiment is similar to the first embodiment, and the cold mirror 31 which is made of the blue plate glass folds visible light from the light source 1 at a 90-degree angle, and the UVIR components transmit the cold mirror 2 and are emitted out of the optical path from the aperture in the engine cabinet 30. The mirror surface of the cold mirror 2 is cooled by cooling air from the fan 32. The projector engine 40 is provided to project image light to a mirror 52 provided at a rear surface of the mirror body, and a lens 20a is provided to project image light in obliquely backward direction.

The mirror 52 reflects image light projected from the lens 20a to form an image of image light on a screen 51.

In the projector engine 40, the light source 1 and a projection lens 20a are placed respectively at each end of the U-shape arrangement, and the light source 1 and the projection lens 20a are positioned at the lower front of the screen 51. Consequently, when the light source 1 is replaced, the light source 1 may be detached from the lower front of the screen 51. It may also be easy to replace.

In the rear projection display device illustrated in FIG. 5 to FIG. 7, the projector engine is used according to the first embodiment, or otherwise, the structure of the projector engine according to the second and third embodiments may also be applied.

It should be understand that the embodiments disclosed herein are to be taken as examples in every point and are not limited. The scope of the present invention is defined not by the above described embodiments but by the appended claims. All changes that fall within means and bounds of the claims, or equivalence of such means and bounds are intended to be embraced by the claims

The present invention is used to the projection display device such as projector and rear projector.

It should be understood that the embodiments disclosed herein are to be taken as examples and not limited. The scope of the present invention is defined not by the above described embodiments but by the following claims. All changes that fall within means and bounds of the claims, or equivalence of such means and bounds are intended to be embraced by the claims.

What we claim is:

1. A projection display device comprising:
a light source composed of a lamp and a parabolic reflector;
a mirror that folds light from the light source to be applied to a fly-eye integrator;
a light modulating element to which light through the fly-eye integrator is directed; and
a projection lens enlarging and projecting light modulated by the light modulating element onto a screen, wherein
the reflector is a metallic reflector, further comprising:
an apparatus cooling the mirror to which light including visible light, ultraviolet and infrared rays is applied from the light source; and
an apparatus removing ultraviolet and infrared rays from the light from the light source, wherein
the apparatus for removing ultraviolet and infrared rays is arranged so as to prevent retroreflection of the removed ultraviolet and infrared rays to a lamp side.

2. The projection display device according to claim 1, further comprising:
the mirror made of a blue plate glass;
an air vent provided on upper and lower sides of an installation surface of the mirror; and
a cooling apparatus passing through cooling air along the mirror surface, thereby cooling the mirror surface.

3. The projection display device according to claim 1, further comprising:
a heat sink provided on a rear surface of the mirror to be formed in consideration of a temperature distribution of the mirror.

4. The projection display device according to claim 1, wherein
a cold mirror is used for the mirror to be constructed to emit ultraviolet and infrared rays transmitted through the cold mirror out of an optical path.

5. The projection display device according to claim 4, further comprising:
the mirror made of a blue plate glass;
an air vent provided on upper and lower sides of an installation surface of the mirror; and
a cooling apparatus passing through cooling air along the mirror surface, thereby cooling the mirror surface.

6. The projection display device according to claim 4, further comprising:
a heat sink provided on a rear surface of the mirror to be formed in consideration of a temperature distribution of the mirror.

7. The projection display device according to claim 1, further comprising:
the mirror which is a total reflection mirror; and
an ultraviolet and infrared ray cut filter disposed obliquely to an optical path between lenses of the fly-eye integrator, thereby constructed to emit ultraviolet and infrared rays reflected by the ultraviolet and infrared cut filter out of the optical path.

8. The projection display device according to claim 7, further comprising:
the mirror made of a blue plate glass;
an air vent provided on upper and lower sides of an installation surface of the mirror; and
a cooling apparatus passing through cooling air along the mirror surface, thereby cooling the mirror surface.

9. The projection display device according to claim 7, further comprising:
a heat sink provided on a rear surface of the mirror to be formed in consideration of a temperature distribution of the mirror.

10. The projection display device according to claim 1, further comprising:
the mirror which is a total reflection mirror;
an ultraviolet and infrared ray cut filter covering a lens surface facing the mirror of the fly-eye integrator, thereby diffusing reflected light of ultraviolet and infrared rays to the lamp side.

11. The projection display device according to claim 10, further comprising:
the mirror made of a blue plate glass;
an air vent provided on upper and lower sides of an installation surface of the mirror; and
a cooling apparatus passing through cooling air along the mirror surface, thereby cooling the mirror surface.

12. The projection display device according to claim 10, further comprising:
a heat sink provided on a rear surface of the mirror to be formed in consideration of a temperature distribution of the mirror.
